(19) United States
(12) Patent Application Publication
(10) Pub. No.: US 2008/0195893 A1
(43) Pub. Date: Aug. 14, 2008

(54) A REPAIRABLE SEMICONDUCTOR MEMORY DEVICE AND METHOD OF REPAIRING THE SAME

(75) Inventors: Byeong Hoon LEE, Mapo-gu (KR); Ki Hong KIM, Suwon-si (KR); Seung Won LEE, Seongnam-si (KR); Sun Kwon KIM, Suwon-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Gyeonggi-do (KR)

(21) Appl. No.: 11/845,194

(22) Filed: Aug. 27, 2007

(30) Foreign Application Priority Data
Feb. 8, 2007 (KR) 10-2007-0013238

(51) Int. Cl. G06F 11/00

(52) U.S. Cl. 714/23; 714/E11.001

(57) ABSTRACT

A repairable semiconductor memory device including a memory cell array having a first block to store first system data and a second block to store second system data identical to the first system data. A controller transmits the first system data to a memory unit in response to a reset signal output from a host and the second system data to the memory unit based on a fail detection signal generated by an ECC detection block. The ECC detection block determines whether the first system data is defective. When a defect is generated in the first system data during resetting of the semiconductor memory device, the first system data is repaired by supplying the second system data.

### CROSS-REFERENCE TO RELATED APPLICATION

This U.S. non-provisional application claims priority under 35 U.S.C. §119 of Korean Patent Application No. 10-2007-0013238 filed on Feb. 8, 2007, the entire contents of which are hereby incorporated by reference.

### BACKGROUND OF THE INVENTION

1. Field of the Invention

Embodiments of the invention relate to a semiconductor memory device. More particularly, embodiments of the invention relate to a repairable semiconductor memory device and a method of repairing the semiconductor memory device.

2. Discussion of Related Art

Non-volatile semiconductor memory devices (for example, flash memory devices) retain data even in the absence of power. These devices are being widely used as data storage devices included in various digital electronic products, such as PCs, personal digital assistants (PDAs), digital cameras, mobile phones, and mp3 players. Such non-volatile semiconductor memory devices include a memory cell array having a plurality of blocks, each of which includes a plurality of pages having memory cells that share a single wordline. These devices also include a redundant block. When a defect (caused during manufacturing) is detected in a specific memory block, the defective or bad block is replaced by a redundant block, thereby reducing the manufacturing defect rate. A defective block generated during the use of a non-volatile memory device is treated by software applications as a defective block. However, there are circumstances when a block at a specific location cannot be treated as a defective block, but the data stored in the block must be read.

FIG. 1 is a flowchart of a conventional method of booting a semiconductor memory device when data stored in a defective or bad memory block is assumed as booting data. When a non-volatile memory device is connected to an electronic system and booted, a controller (not shown) copies booting data stored in a first memory block into a memory (for example, a boot memory) in response to a reset signal (for example, a cold reset signal), in step S10. In step S20, an error correction code (ECC) detecting block (not shown) detects whether the booting data is defective. When the booting data is not defective, the electronic system is reset in step S40 and the electronic system starts at step S50. When the booting data is defective, the semiconductor memory device is treated as a failure in step S30 so that a booting failure occurs. In this case, since the time when the booting data stored in the first block is copied into memory in step S10 is before the electronic system is reset (that is, the time when the CPU of the electronic system starts a reset operation), it may be impossible for the electronic system to process a booting failure via software. Security information associated with a memory device, for example manufacturing date, serial number, etc., is usually stored only once in a one time programmable (OTP) block. If the OTP block is the bad or defective memory block, the semiconductor memory device may malfunction because of inaccessibility of the security information during operation of the memory device.

### SUMMARY OF THE INVENTION

Exemplary embodiments of the present invention are directed to a semiconductor memory device that can be repaired by replacing a bad memory block generated during booting with another block. In an exemplary embodiment the semiconductor memory device includes a memory cell array comprising a first block configured to store first system data and a second block configured to store second system data identical to the first system data. A controller communicates with the memory cell array. The controller is configured to transmit the first system data to a first memory unit in response to a reset signal output from a host. An ECC detection block communicates with the memory cell array. The ECC detection block is configured to generate a fail detection signal when the first system data is defective. The controller is further configured to transmit the second system data to the first memory unit based on receipt of the fail detection signal.

In another exemplary embodiment, an associated method of repairing a semiconductor memory device includes transmitting first system data to a memory unit in response to a reset signal from a controller. A determination is made by the controller as to whether the first system data is defective. The second system data identical to the first system data is generated to the memory unit based on a fail detection signal generated by an ECC (error correction code) detection block.

### BRIEF DESCRIPTION OF THE DRAWINGS

FIG. 1 is a flowchart of a method of booting a related art semiconductor memory device;

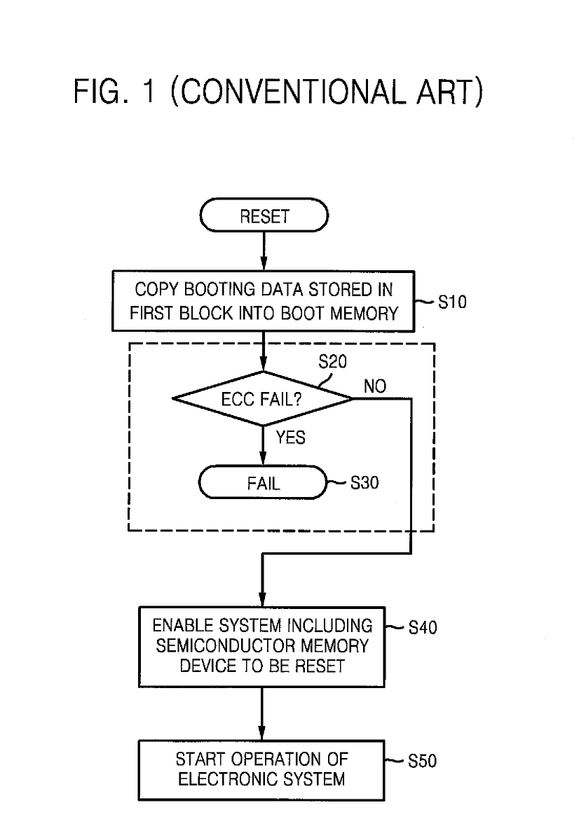

FIG. 2 is a block diagram of a semiconductor memory device according to an embodiment of the present invention;

FIG. 3 is a block diagram of a first memory unit shown in FIG. 1;

FIG. 4 is a schematic diagram of an electronic system according to an embodiment of the present invention;

FIGS. 5A-5J illustrate electronic apparatuses including the electronic system shown in FIG. 4;

FIG. 6 is a flowchart of a method of repairing the semiconductor memory device illustrated in FIGS. 2 and 3, according to an embodiment of the present invention;

FIG. 7 is a flowchart of a method of repairing the semiconductor memory device illustrated in FIGS. 2 and 3, according to another embodiment of the present invention.

### DESCRIPTION OF EMBODIMENTS

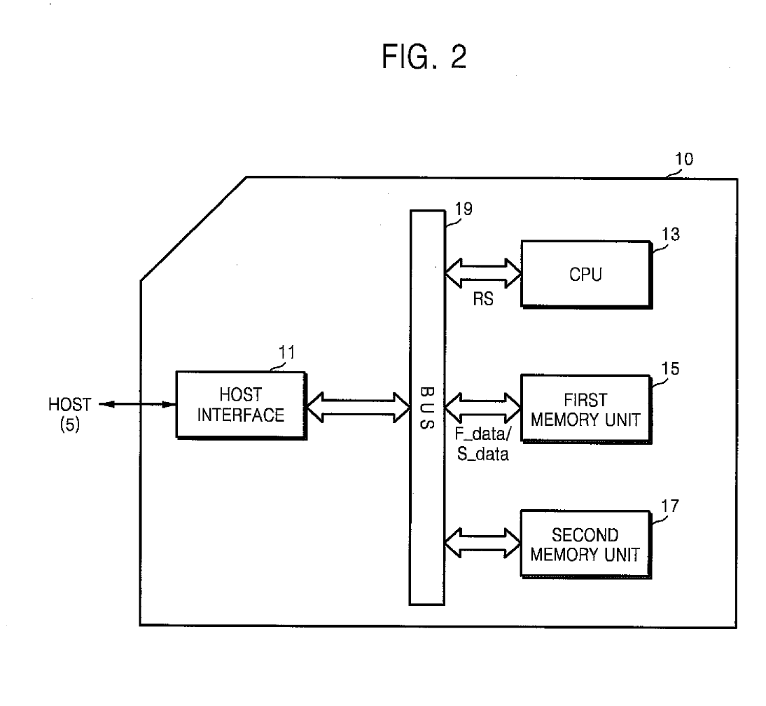

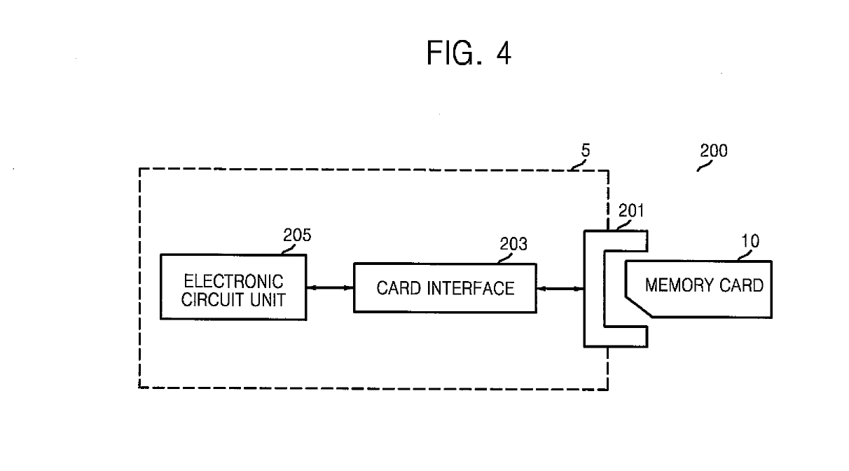

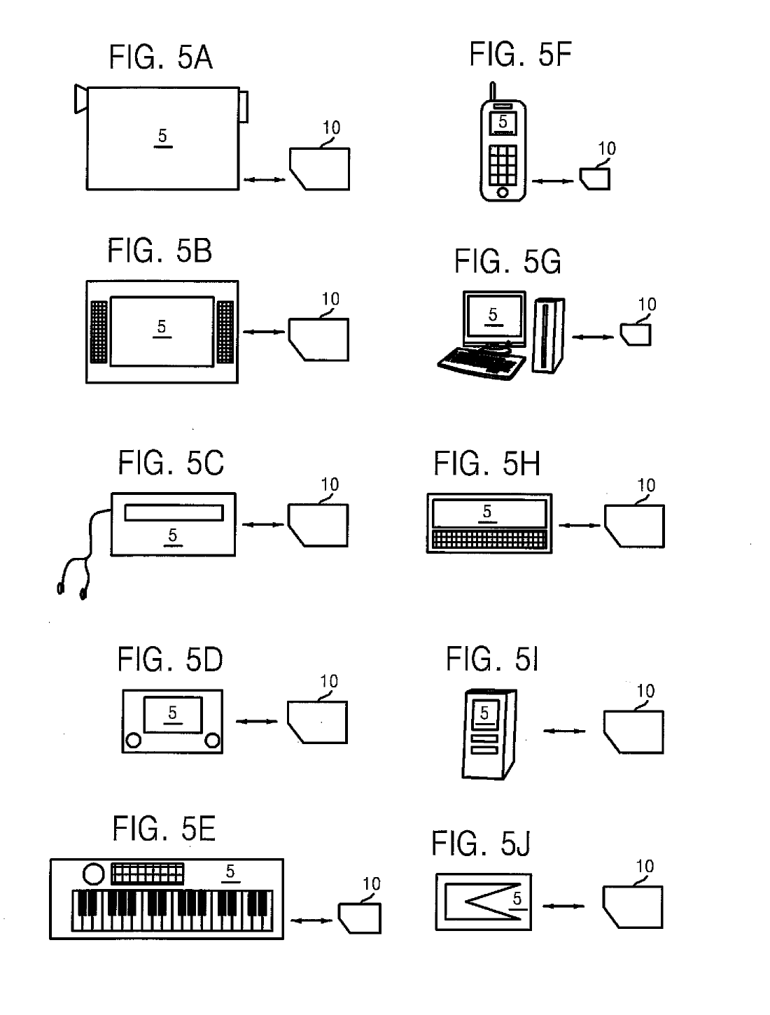

Referring to FIGS. 2-5, the semiconductor memory device 10 includes a host interface 11, a CPU 13, a first memory unit 15, a second memory unit 17, and a bus 19. The semiconductor memory device 10 may be a memory card, a compact flash, a memory stick, a memory stick duo, a multimedia card (MMC), a miniaturized MMC, a secure digital (SD) card, a mini SD card, a micro SD card (e.g., a Transflash™), a smart media card, or an XD-picture card™, etc. Semiconductor memory device 10 may be electrically connected to a memory slot 201 of FIG. 4 in order to store data (for example, image data or audio data) output from electronic circuit unit 205 via card interface 203 installed in a host 5. Alternatively, memory device 10 may also be configured to transmit stored data to electronic circuit unit 205 of host 5. For example, when host 5 is a video camera (as shown in FIG. 5A), the electronic circuit unit 205 may include a CMOS image sensor (CIS), an image processor, and a digital signal processing unit to transmit data (for example, image data or audio data) output from electronic circuit unit 205 via card interface 203 of FIG. 4 to memory device 10. Semiconductor memory device 10 may be installed in a video camera (shown in FIG. 5A), a television (shown in FIG. 5B), an MP3 player (shown in FIG. 5C), a game device (shown in FIG. 5D), an electronic instrument (shown in FIG. 5E), a portable terminal (shown in FIG. 5F), a personal computer (PC, shown in FIG. 5G), a personal digital assistant (PDA, shown in FIG. 5H), a voice recorder (shown in FIG. 5I), a PC card (shown in FIG. 5J), etc.

Host interface 11 transmits a command and/or data output from host 5 to CPU 13 via bus 19. Host interface 11 also provides data stored in first memory unit 15 and second memory units 17 to host 5 via bus 19. CPU 13 generates a reset signal RS (for example, a cold reset signal) based on a power up signal generated by host 5. Reset signal RS may be an initialization signal for booting an electronic system (for example, the electronic system 200 of FIG. 4) including semiconductor memory device 10 after power is supplied to memory device 10, but before the electronic system starts. First memory unit 15 generates a fail detection signal FDS based on reset signal RS and first system data F_data and outputs the first system data F_data or second system data S_data equal to the first system data F_data. First and second system data, which are identical to each other, may be booting data for semiconductor memory device 10. The booting data is stored (or installed) during a basic input/output service (BIOS) operation associated with host 5. For example, the booting data may include data associated with the CMOS setup check of host 5, loading of an interrupt handler and device drivers, initialization of registers and device management, a power on self-test (POST) of components (such as disk drives or peripheral devices), representation of a system setting, or a program allowing a boot strap sequence to start. Alternatively, first and second system data may correspond to data to be stored in a one time programmable (OTP) block of semiconductor memory device 10. The data stored in the OTP block relates to security information of the semiconductor memory device 10 which may be, for example, the manufacturing date of device 10, the serial number of the device manufacturer, or similar type data.

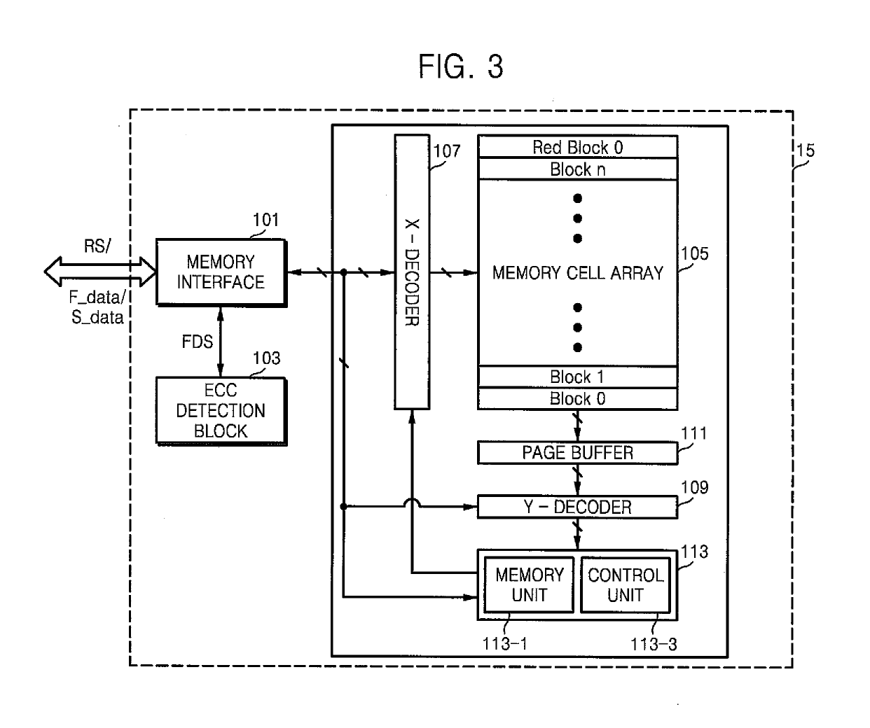

FIG. 3 illustrates first memory unit 15 shown in FIG. 2 which includes memory interface 101, error correction code (ECC) detection block 103, memory cell array 105, X-decoder 107, Y-decoder 109, page buffer 111, and controller 113. Memory interface 101 transmits first system data F_data or second system data S_data to CPU 13, second memory unit 17, or ECC detection block 103. Memory interface 101 may also transmit command and/or data received via CPU 13 to controller 113 or transmits main data (for example, audio or video data transmitted via host 5) stored in memory cell array 105 to CPU 13 or host 5. ECC detection block 103 detects a fail or a non-fail of first system data F_data or second system data S_data in response to an ECC detection control signal (not shown) generated by CPU 13 and generates fail detection signal FDS. ECC detection block 103 compares an ECC value generated when a first block Block 0 of memory cell array 105 writes on the first system data F_data with an ECC value generated when the first block Block 0 of memory cell array 105 reads first system data F_data in order to generate fail detection signal FDS based on the detection result.

When the ECC value generated when writing first system data F_data is equal to the value generated when first system data F_data is read, ECC detection block 103 generates a fail detection signal FDS with a first logic level (for example, a high logic level “1”). Alternatively, when the ECC value generated when writing first system data F_data is different from that generated when first system data F_data is read, ECC detection block 103 generates a fail detection signal FDS with a second logic level (for example, a low logic level “0”).

Memory cell array 105 may include a plurality of blocks Block0-Blockn and Red Block0 where each block includes a plurality of pages having a plurality of memory cells that share a single wordline. First memory block Block0 stores first system data F_data and second block Red Block0 stores second system data S_data. The X-decoder or row decoder 107 selects one of the blocks Block0-Blockn and Red Block0 in response to a block address generated by controller 113. Based on this generated row address, X-decoder 107 selects one of a plurality of wordlines of the selected block. The Y-decoder or column decoder 109 selects one of a plurality of bitlines of the selected block based on a column selection signal generated by controller 113. Page buffer 111 senses and amplifies the data stored in the cells selected by X-decoder 107 and Y-decoder 109.

Controller 113 transmits first system data F_data to second memory unit 17 in response to reset signal RS. Controller 113 transmits second system data F_data to second memory unit 17 based on fail detection signal FDS generated by ECC detection block 103. Controller 113 includes memory unit 113-1 and control unit 113-3. Memory unit 113-1 stores an address (or flag) associated with first block Block0 or an address (or flag) of second block Red Block0. Memory unit 113-1 may be implemented as a non-volatile memory device which may be, for example, a mask ROM, an Electrically Erasable and Programmable Read Only Memory (EEPROM), or an Erasable and Programmable Read Only Memory (EPROM). When first block Block0 is a defective block, semiconductor memory device 10 can provide the address of the second block Red Block0, which is a replacement of first block Block0, to control unit 113-3 even during the reset operation.

When first system data F_data and second system data S_data are booting data and an error is generated upon booting of the semiconductor memory device 10, this booting data can be repaired. In particular, when first system data F_data and the second system data S_data correspond to data that is stored in the OTP block, the first system data F_data can be replaced by the second system data S_data and repaired during a generation of a fail response associated with the first system data F_data. Control unit 113-3 transmits first system data F_data corresponding to the address of first block Block0 to second memory unit 17 in response to reset signal RS. Control unit 113-3 also transmits second system data S_data corresponding to the address of second block Red Block0 to second memory unit 17 based on the fail detection signal FDS.

Second memory unit 17 stores the first system data F_data or the second system data S_data and may also be used as system work memory. For example, second memory unit 17 may store the first system data F_data or the second system data S_data and transmit the first system data F_data or the second system data S_data to CPU 13 during the booting of semiconductor memory device 10 to boot the device faster. Second memory unit 17 may be implemented as a volatile memory because it consecutively receives and stores the first system data F_data or the second system data S_data from first memory unit 15. The volatile memory may be, for example, a synchronous random access memory (SRAM) or a dynamic random access memory (DRAM).

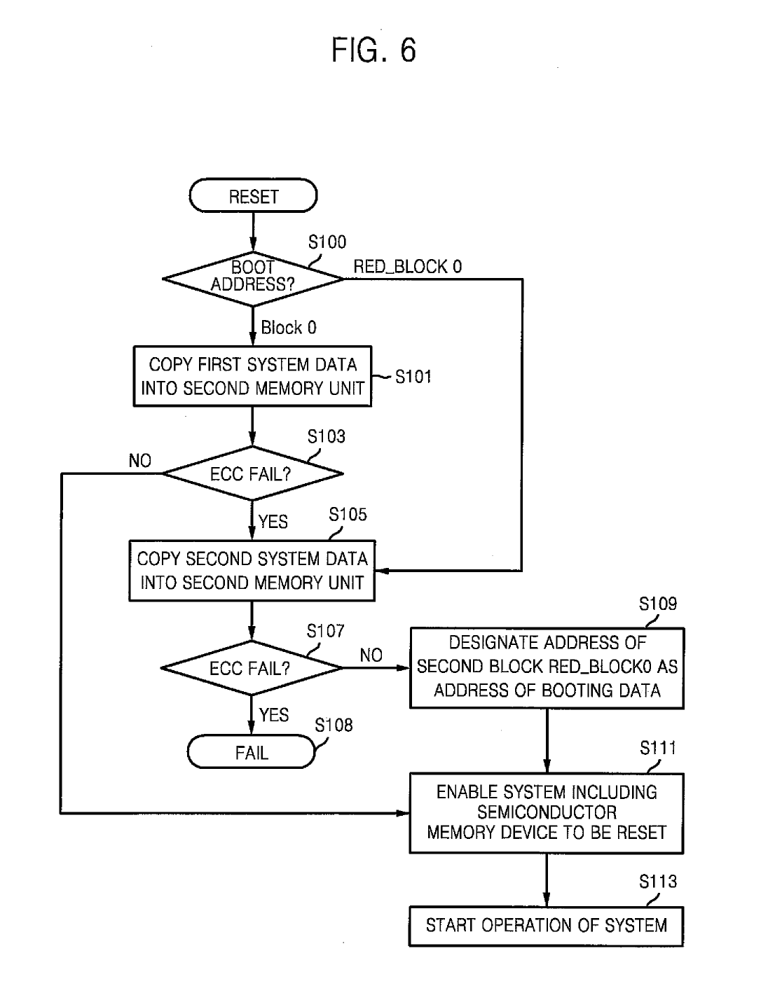

FIG. 6 is a flowchart of a method of repairing the semiconductor memory device illustrated in FIGS. 2 and 3. Referring to FIGS. 2, 3, and 6, control unit 113-3 detects the address associated with the system booting data based on the address stored in memory unit 113-1 in step S100. When the address of the booting data is the address of the first block Block0, control unit 113-3 copies the first system data F_data into second memory unit 17 in step S101. When the address of the booting data is the address of second block Red_Block0, control unit 113-3 copies the second system data S_data associated with the address of the second block Red_Block0 into second memory unit 17 in step S105. In step S103, ECC detection block 103 determines whether first system data F_data stored in the second memory unit 17 failed or did not fail in response to ECC detection control signal generated by CPU 13. When step S103 determines that first system data F_data failed, control unit 113-3 performs step 105 and copies second system data S_data associated with the address of second block Red_Block0 into second memory unit 17. When step S103 determines that the first system data F_data did not fail, CPU 13 enables the system having semiconductor memory device 10 and host 5 to reset based on the first system data F_data in step S111.

In step S107, ECC detection block 103 determines whether the second system data S_data stored in second memory unit 17 failed or did not fail in response to the ECC detection control signal generated by CPU 13. When step S107 determines that the second system data S_data did not fail, control unit 113-3 designates the address associated with second block Red_Block0 as the address of the booting data and transmits the address of the second block Red_Block0 to second memory unit 17 in step S109. When step S107 determines that the second system data S_data failed, CPU 13 reports a fail of semiconductor memory device 10 in step S108. In step S113, CPU 13 enables the system having semiconductor memory device 10 and host 5 to reset using first system data F_data.

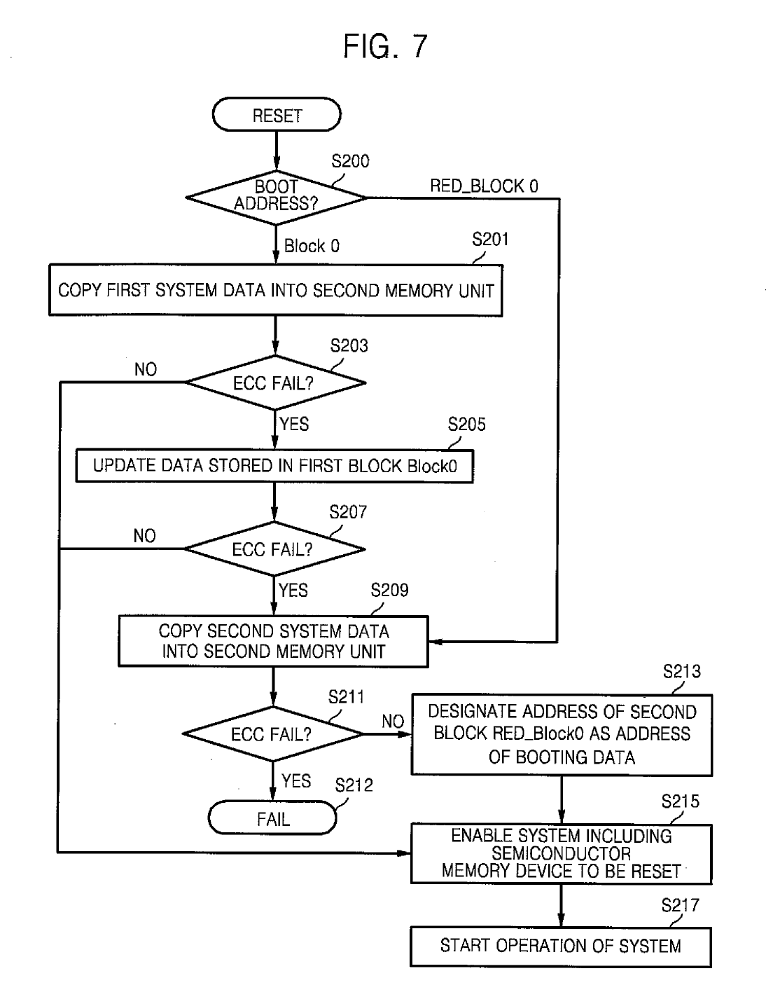

FIG. 7 is a flowchart of a method of repairing the semiconductor memory device illustrated in FIGS. 2 and 3. The semiconductor memory device repairing method of FIG. 7 is different from the semiconductor memory device repairing method of FIG. 6 in that the method described in FIG. 7 includes step S205. In step S205, when first system data F_data failed, control unit 113-3 updates the data stored in first block Block0 based on a command and data outputted from CPU 13. In particular, control unit 113-3 detects the address of booting data based on the address stored in memory unit 113-1 in step S200. When the address of the booting data corresponds to the address of first block Block0, control unit 113-3 copies first system data F_data associated with the address of the first block Block0 into second memory unit 17 in step S201. When the address of the booting data corresponds to the address of second block Red Block0, control unit 113-3 copies the second system data S_data associated with the address of second block Red Block0 into second memory unit 17 in step S209.

In step S203, ECC detection block 103 determines whether first system data F_data stored in second memory unit 17 failed or did not fail in response to the ECC detection control signal (not shown) generated by CPU 13. When sep S203 determines that the first system data F_data failed, control unit 113-3 performs step S205 of updating the data stored in first block Block0 based on the command (not shown) and data (not shown) outputted from the CPU 13. When step S203 determines that the first system data F_data did not fail, CPU 13 enables the system having semiconductor memory device 10 and host 5 to be reset based on first system data F_data in step S215 and the system starts in step S217. ECC detection block 103 determines whether or not the updated first system data F_data failed or did not fail in response to ECC detection control signal (not shown) generated by CPU 13 in step S207.

When step S207 determines that the updated first system data F_data failed, control unit 113-3 performs step S209. When step S207 determines that the updated first system data F_data did not fail, CPU 13 performs step S215 and the system starts at step S217. In step S211, ECC detection block 103 determines whether or not a fail or a non-fail of the second system data S_data stored in the second memory unit 17 failed or did not fail in response to the ECC detection control signal (not shown) generated by CPU 13. When step S211 determines that the second system data S_data did not fail, control unit 113-3 designates the address of second block Red_Block0 as the address for the booting data and transmits this address to second memory unit 17 in step S213 and CPU 13 performs step S215. The system having semiconductor memory 10 is started at step S217. When step S211 determines that the second system data S_data failed, CPU 13 reports a fail of the semiconductor memory device 10 in step S212.

As described above, when a defective or bad block is generated during the booting operation of a system having a semiconductor memory device in accordance with the present invention, the defective block can be repaired by replacing it with another block. In addition, when an OTP block during resetting of the semiconductor memory device is the defective block, the OTP block can be repaired by being replaced with another block.

Although the present invention has been described in connection with the embodiment of the present invention illustrated in the accompanying drawings, it is not limited thereto. It will be apparent to those skilled in the art that various substitutions, modifications and changes may be made thereto without departing from the scope and spirit of the invention.

What is claimed is:

1. A method of repairing a semiconductor memory device with a defective memory cell block comprising:
transmitting first system data to a memory unit in response to a reset signal from a controller;
determining whether the first system data is defective using said controller; and
transmitting second system data identical to the first system data to said memory unit based on a fail detection signal generated by an ECC (error correction code) detection block communicating with said controller.

2. The method of claim 1, wherein the first system data is stored in a first block of a memory cell array and the second system data is stored in a second block of the memory cell array.

3. The method of claim 1 wherein the reset signal is generated in response to a power up signal supplied by a host

4. The method of claim 1 wherein the reset signal generated by a host.

5. A semiconductor memory device comprising:
a memory cell array comprising a first block configured to store first system data and a second block configured to store second system data identical to said first system data; and
a controller communicating with said memory cell array, said controller configured to transmit said first system data to a first memory unit in response to a reset signal output from a host;
an ECC detection block communicating with said memory cell array, said ECC detection block configured to generate a fail detection signal when said first system data is defective, said controller further configured to transmit said second system data to said first memory unit based on receipt of said fail detection signal.

6. The semiconductor memory device of claim 5, wherein the controller further comprises:
a second memory unit storing an address associated with said first block and an address associated with said second block; and
a control unit configured to transmit said first system data associated with said address of the first block to the first memory unit in response to the reset signal, said control unit further configured to transmit the second system data associated with said address of the second block to the first memory unit based on said fail detection signal.

7. The semiconductor memory device of claim 5 wherein the semiconductor memory device is a flash EEPROM (Electrically Erasable and Programmable Read Only Memory).

8. A method of repairing a semiconductor memory device, comprising:
generating a reset signal based on a power up signal supplied by a host having a CPU (central processing unit);
generating a fail detection signal when said first system data is defective;
supplying said fail detection signal to said CPU;
outputting first system data or second system data identical with the first system data based on the reset signal and said fail detection signal using a first memory unit;
storing the first system data or the second system data in a second memory unit; and
booting the semiconductor memory device based on the first system data or the second system data stored in the second memory unit using said CPU.

9. The method of claim 8 wherein said fail detection signal is generated by an Error Correction Code detection block, said operation of outputting the first system data or the second system data comprises:
transmitting the first system data to the second memory unit in response to the reset signal using a controller; and
transmitting the second system data to the second memory unit using the controller.

10. The method of claim 1, wherein the first system data and the second system data corresponding to booting data of the semiconductor memory device.

11. The method of claim 1, wherein the first system data and the second system data correspond to data stored in a one time programmable (OTP) block.

12. The method of claim 8, wherein the first system data and the second system data correspond to booting data of the semiconductor memory device or data stored in an OTP block.

13. The method of claim 8, wherein the first system data and the second system data correspond to data stored in an OTP block.

14. A semiconductor memory device having first system data and second system data, said device comprising:
a CPU generating a reset signal based on a power up signal generated by a host;
a first memory unit communicating with said CPU and generating a fail detection signal when said first system data is defective based on the reset signal and the first system data, said first memory unit outputting the first system data or the second system data identical with the first system data based on the fail detection signal; and
a second memory unit communicating with said first memory unit and storing the first system data or the second system data.

15. The semiconductor memory device of claim 14, wherein the first memory unit comprises:
a memory cell array comprising a first block configured to store the first system data and a second block configured to store the second system data;
an ECC detection block detecting whether the first system data or the second system data is defective in response to an ECC detection control signal generated by the CPU, said ECC detection block generating the fail detection signal; and
a controller transmitting the first system data to the second memory unit in response to the reset signal, said controller also transmitting the second system data to the second memory unit based on the fail detection signal generated by the ECC detection block.

16. The semiconductor memory device of claim 15 wherein the controller comprises:
a memory unit storing an address associate with the first block or an address associated with the second block; and
a control unit communicating with said memory unit, said control unit transmitting the first system data indicated by the address of the first block to the second memory unit in response to the reset signal and transmitting the second system data indicated by the address of the second block to the second memory unit based on the fail detection signal from said ECC detection block.

17. The semiconductor memory device of claim 14, wherein the first system data and the second system data correspond to booting data of the semiconductor memory device or data stored in an OTP block.

18. The semiconductor memory device of claim 14, wherein the first system data and the second system data correspond to data stored in an OTP block.
